(19) United States
(12) Patent Application Publication
(10) Pub. No.: US 2026/0155574 A1
(43) Pub. Date: Jun. 4, 2026

(54) LOG-PERIODIC LATTICE FOR AN ANTENNA ARRAY

(71) Applicant: The Aerospace Corporation, El Segundo, CA (US)

(72) Inventor: Mark J. LANGE, Malibu, CA (US)

(73) Assignee: The Aerospace Corporation, El Segundo, CA (US)

(21) Appl. No.: 18/968,524

(22) Filed: Dec. 4, 2024

(51) Int. Cl. H01Q 11/10; H01Q 5/25

(52) U.S. Cl. CPC H01Q 11/105; H01Q 5/25

(57) ABSTRACT

An array lattice for a low-density array includes a plurality of antenna elements. Each pair of the plurality of antenna elements are spaced such that each pair of the plurality of antenna elements have different spacing. Furthermore, each pair of the plurality of antenna elements has a grating lobe steered to a different angle while a main beam is the only beam that is coherently combined by each pair of the plurality of antenna elements. The array lattice results in grating lobe rejection that is directly proportional to the number of antenna elements.

### CROSS-REFERENCE TO RELATED APPLICATIONS

This application is related to co-pending U.S. application Ser. No. 18/752,223, filed on Jun. 24, 2024, in which the subject matter of the co-pending application is incorporated herein by reference.

### FIELD

The present invention generally pertains to antennas, and more particularly, to Electronically Scanned Array Antennas and the manner in which the array lattice is configured.

### BACKGROUND

It is well known in phased array antenna theory that using an antenna element spacing greater than a half wavelength at the highest operating frequency allows grating lobes to form in the forward hemisphere when the main beam is scanned away from normal to the plane of the array. If the element spacing is greater than one wavelength at the highest operating frequency, grating lobes will appear in the forward hemisphere without any beam scanning. While the term, grating lobe is well known in the art, it is meant here to describe any number of additional beams other than the desired beam formed by the array due to spacing greater than a half wavelength. This does not include side lobes caused by diffraction from the edge of any antenna aperture. It is typically accepted in the art that grating lobe free operation requires S/λ<1/(1+|sinθ|), where S is the element spacing, λ is the wavelength, and θ is the beam scan angle from the array normal.

There are many examples where wideband array antennas have tried to squeeze wideband elements so close together in an attempt to prevent the formation of grating lobes. See FIGS. 1A-C, which are diagrams of related art showing an antenna array 100 with uniform lattice spacing. However, by doing this, the antenna elements must grow in significant height to operate across the lower frequencies of the wide bandwidth. This approach results in strong mutual coupling between adjacent elements, which degrades the performance in many ways and increases the size, weight, power consumption and cost of the array antenna. Essentially, the antenna array is designed for higher frequency with the smaller element spacing causing the element density to be much greater than needed across the rest of the frequency band.

Another approach previously used to reduce the grating lobes in an array without using such a small antenna element spacing is to utilize an aperiodic lattice with random spacing. This is a very inefficient method of reducing grating lobes and requires a statistically large number of antenna elements to prevent systematic disturbances in the radiation patterns. Additionally, even though there is a large number of antenna elements in the array, the side lobes and grating lobes remain very high.

Additionally, antenna arrays have historically had narrow bandwidths with elements measuring less than half a free space wavelength across. The relatively small antenna element allows for an array lattice that is close to that of a half wavelength at the operating frequency. It is well-know that an array element spacing of a half wavelength or less will not produce grating lobes in the visible space above a ground plane for any beam scan angle within that visible space (some part of the upper hemisphere). Further, antenna elements that are less than a half wavelength across provide a wide radiation pattern beamwidth that enables the array to have a wide beam scan angle without significant beam scanning loss. Besides the drawback of a narrow bandwidth, small antenna elements and the associated small element spacing in a large array have the undesirable side effect of significant size, weight, power, and cost.

Another drawback of closely spaced elements is the strong mutual coupling between adjacent elements. This results in power radiated from one element being received or absorbed by the adjacent elements. Strong mutual coupling reduces the efficiency of the array and can cause scan blindness at beam scan angles where nearly all the power transmitted out of the array is also received back into the array.

Some attempts have been made at reducing size, weight, power, and cost in narrow-band-thinned arrays by using randomized element spacing. This approach tends to introduce systematic asymmetric radiation patterns in small to medium sized arrays as very large array element counts are required to approach a truly random lattice. Additionally, this approach arbitrarily weighs the outer regions of the array more heavily than the inner regions of the array. This causes larger side lobe levels than a uniformly spaced array lattice.

Multi-Octave antennas are highly desirable but particularly challenging when used in an array. For most antennas, the element must be approximately a half wavelength long at the lowest operating frequency. The size of the element at the lowest frequency sets the minimum possible element spacing for the entire array. For a 2-octave array, this element becomes 2 wavelengths across at the highest operating frequency. The large element spacing produces grating lobes in the visible space above a ground plane at higher frequencies.

Some attempts have been made to reduce the multi-octave element spacing to that of a half wavelength at the highest operating frequency, thus eliminating the grating lobes, by folding the element halves upward, normal to the ground plane, such as (inset reference) with the well-known Vivaldi antenna. One drawback here is that for large arrays the element count is significantly greater than needed for use at the lower frequencies. Further, the significant height of the element increases the size and weight of the wide band array over a narrow band array. Additionally, narrow Vivaldi antennas have high cross polarization levels at the currents flowing up and down the exposed conductors radiate vertically as well as in the desired horizontal mode. The high element density further consumes a significant amount of power with RF amplifiers, filters and up or down-converters behind each element. Cost of the array also increases with the high element density.

While array antennas have historically been narrow-banded, there are significant benefits to achieving Multi-Octave Arrays with good performance and low size, weight, power and cost.

Accordingly, an improved lattice for wide band antenna elements is needed.

### SUMMARY

Certain embodiments of the present invention may provide solutions to the problems and needs in the art that have not yet been fully identified, appreciated, or solved by current antenna array technologies. For example, some embodiments of the present invention pertain to an array lattice for a low-density array of antenna elements. The array lattice is configured to suppress grating lobes associated with each antenna element spacing greater than a half wavelength.

In some embodiments, an array lattice for a low-density array includes a plurality of antenna elements where each pair of the plurality of antenna elements are spaced such that each pair of the plurality of antenna elements have differential spacing. In these embodiments, each pair of the plurality of antenna elements have a grating lobe steered to a different angle while a main beam is the only beam that is coherently combined by each pair of the plurality of antenna elements.

In another embodiment, an array lattice for a low-density array includes a plurality of antenna elements where each pair of the plurality of antenna elements are spaced such that each pair of the plurality of antenna elements have differential spacing. In these embodiments, each pair of the plurality of antenna elements have a grating lobe steered to a different angle while a main beam is the only beam that is coherently combined by each pair of the plurality of antenna elements. Also, in these embodiments, antenna element spacing in a center of the array lattice is smaller compared to antenna elements spacing in other areas of the array lattice to produce an array of antenna elements from the plurality of antenna elements have a higher density in the center and a constantly reducing density towards edges of the array lattice.

In yet another embodiment, an array lattice for a low-density array includes a plurality of antenna elements where each pair of the plurality of antenna elements are spaced such that each pair of the plurality of antenna elements has differential spacing. In these embodiments, the differential spacing is based on a Tau factor ranging from 1.1 and 1.3, and each pair of the plurality of antenna elements have a grating lobe steered to a different angle while a main beam is the only beam that is coherently combined by each pair of the plurality of antenna elements.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting its scope, the invention will be described and explained with additional specificity and detail through the use of the accompanying drawings, in which:

FIG. 1A illustrates the perspective view of a related art array with uniform lattice spacing.

FIG. 1B illustrates the side view of a related art array with uniform lattice spacing.

FIG. 1C illustrates the top view of a related art array with uniform lattice spacing.

FIG. 2 illustrates the radiation pattern of the related art array of FIG. 1.

FIG. 3A is a perspective view illustrating a 1 by 16 element array with a TAU of 1.2, according to an embodiment of the present invention.

FIG. 3B is a top view illustrating a 1 by 16 element array with a TAU of 1.2, according to an embodiment of the present invention.

FIG. 3C is a side view illustrating a 1 by 16 element array with a TAU of 1.2, according to an embodiment of the present invention.

FIG. 4 is a plot illustrating analytical theory and numerically simulated examples of different array antennas with the Log Periodic array lattice, according to an embodiment of the present invention.

FIG. 5A is a graph illustrating the radiation pattern at 8.0 GHz, according to an embodiment of the present invention.

FIG. 5B is a graph illustrating the radiation pattern of at 12.0 GHz, according to an embodiment of the present invention.

FIG. 5C is a graph illustrating the radiation pattern of at 16.0 GHz, according to an embodiment of the present invention.

FIG. 6 is a diagram of related (prior) art showing a circular array 600 with uniform spacing.

FIG. 7A-C are graphs or charts illustrating the high grating lobes associated with the uniform element spacing between antenna elements in the antenna array of FIG. 6.

FIG. 8 is a diagram illustrating a (Log Periodic) circular array lattice with differential spacing of Tau=1.2, according to an embodiment of the present invention.

FIGS. 9A-C are graphs or charts showing the improvement in the grating lobe when Tau=1.2, according to an embodiment of the present invention, shown in FIG. 8.

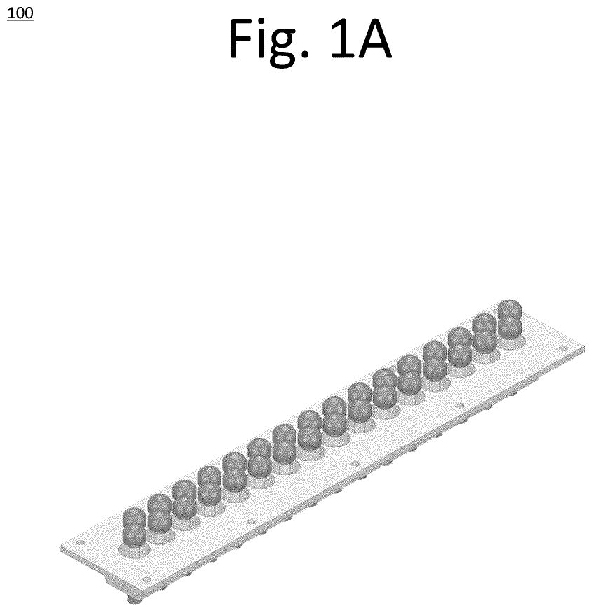

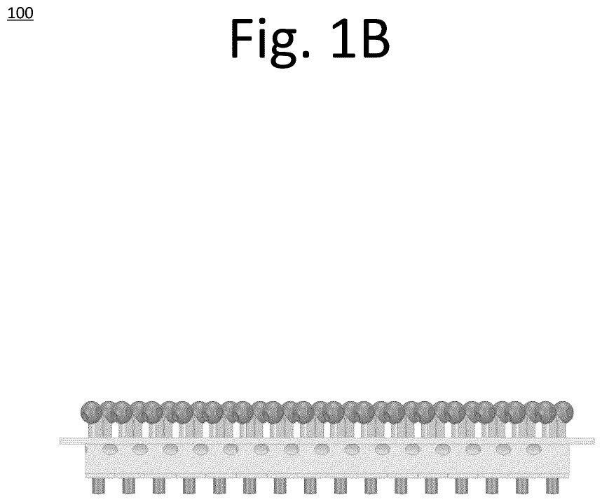

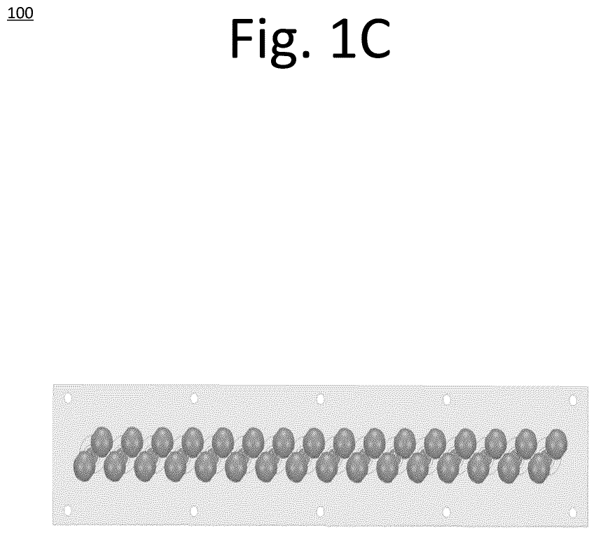

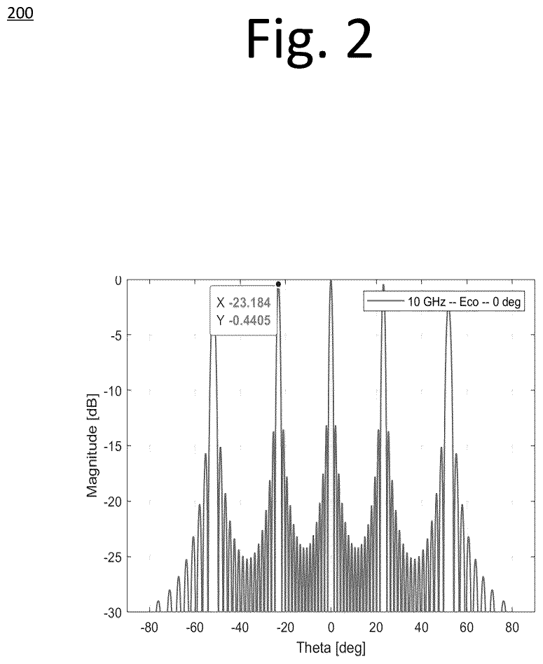

Unless otherwise indicated, similar reference characters denote corresponding features consistently throughout the attached drawings.

### DETAILED DESCRIPTION OF THE PREFERRED EMBODIMENTS

Some embodiments of the present invention pertain to an array lattice for a low-density array of antenna elements. The array lattice is configured to suppress grating lobes associated with each antenna element spacing greater than a half wavelength. By using a Log-Periodic element spacing, no two elements have the same spacing. Thus, each pair of antenna elements has a grating lobe that is steered to a different angle while the main beam is the only beam that is coherently combined. This way, the greater the number of antenna elements in the array, the greater the grating lobe rejection with respect to the main beam. In some embodiments, the grating lobes do not combine as they do with a uniform element spaced array.

In some embodiments, the antenna element spacing in the center of the array of antenna elements is set to be as small as possible given that the wide band element may be much larger than a half wavelength at the highest operating frequency while the Log Periodic function is applied to the element spacing from the center of the array outward. This produces an array of antenna elements with a higher density in the middle and a constantly reducing density going out to the edge of the array of antenna elements. This also produces a low-density array with an efficient amplitude taper across the array aperture even if all the elements are excited with the same power or gain level.

In some embodiments, Log Periodic Array is implemented in Linear Arrays of 1 by N elements, Quasi-Rectangular Arrays of N by M elements or Circular Arrays with M concentric circles.

In general, the element spacing (Si) for the (i^{th} element in the Log Periodic array lattice) may start with the minimum element spacing set by the size of the ultra-wide band antenna element, So. Then, Si=Tau*Si−1. In some embodiments, ultra-wide band antenna element, So, is located at one side of the array, and in other embodiments, ultra-wide band antenna element, So, is located in the center of the array and the element spacing increases outward from the center. Tau is the Log Periodic factor that typically ranges from 1.01 up to 1.30 depending on many factors.

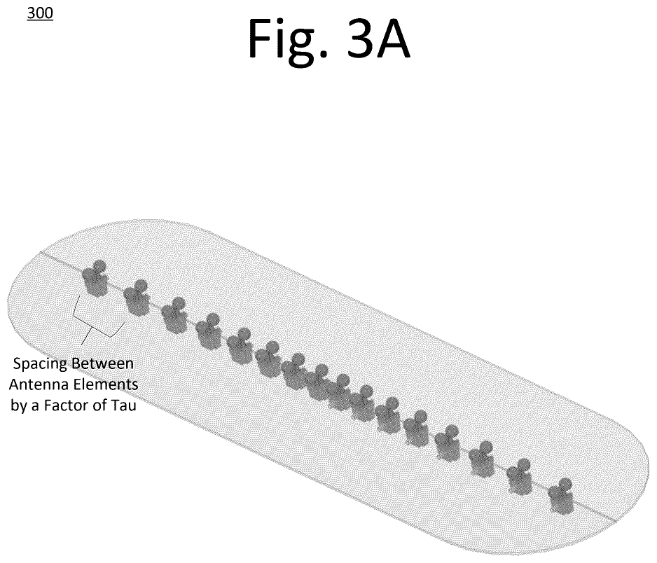

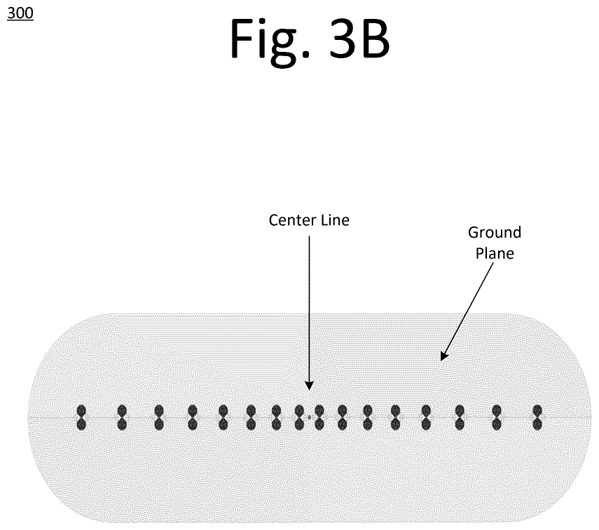

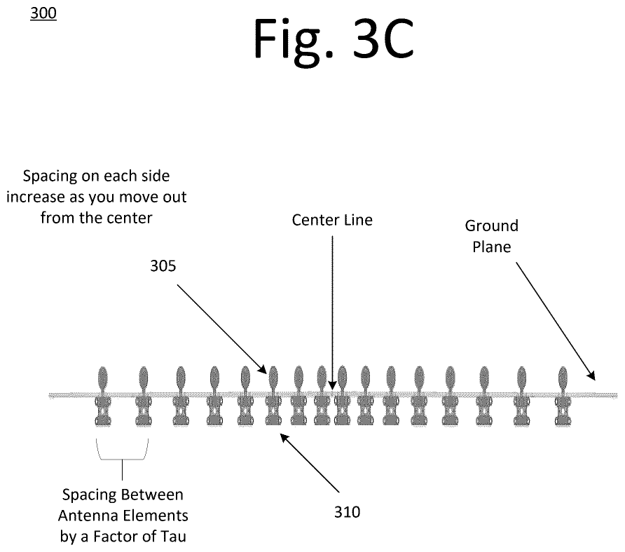

For the Quasi-rectangular Array, Tau is multiplied by element spacing in two orthogonal directions. See, for example, FIGS. 3A-C are perspective views illustrating a 1 by 16 element array 300 with a TAU of 1.2, according to an embodiment of the present invention. As shown in FIG. 3C, lobe 305 is above ground plane 315 and waveguide/balun 310 is below ground plane 315. In some embodiments, starting at the center of 1 by 16 element array 300, the element spacing increases based on the factor Tau. As each element is placed further and further away from the center, the element spacing increases and is symmetrical in spacing compared to the element on the opposite end of 1 by 16 element array. This configuration steers the grating lobe in a different direction for each element pair and the density of the elements are greater in the center than the density of the elements near the edge.

This configuration may offer the advantage of lower weight. If the elements were the same size and same spacing, then the elements may be closer together and with the same spacing and an array of the same size would have a greater number of elements. This may result in a heavier antenna and with a higher grating lobe, creating the problem of grating lobe with wide band antennas.

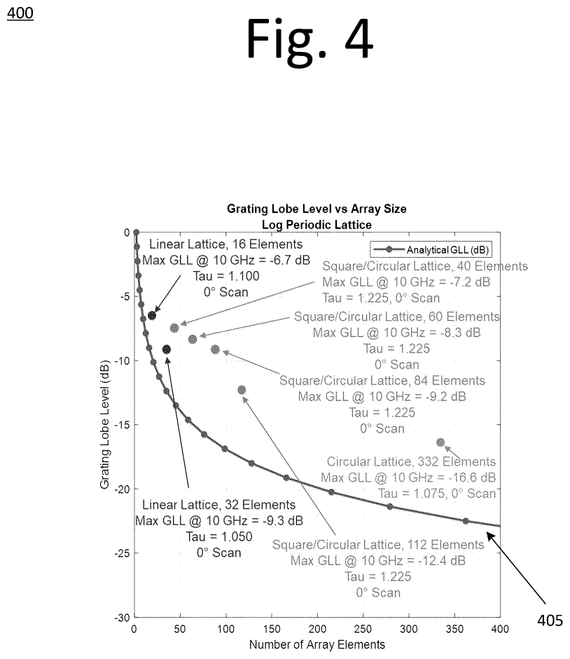

FIG. 4 is a plot 400 of the analytical theory and numerical simulated examples of grating lobe rejections for different array antennas with the Log Periodic array lattice, according to an embodiment of the present invention. In plot 400, a theoretical maximum rejection value 405 is shown as a function of the number of antenna elements. Around theoretical maximum rejection value 405 are test case studies from a numerical simulator. This numerical simulation values show that they are near or around the theoretical maximum value 405. More specifically, the larger the antenna array the better grating lobe rejection.

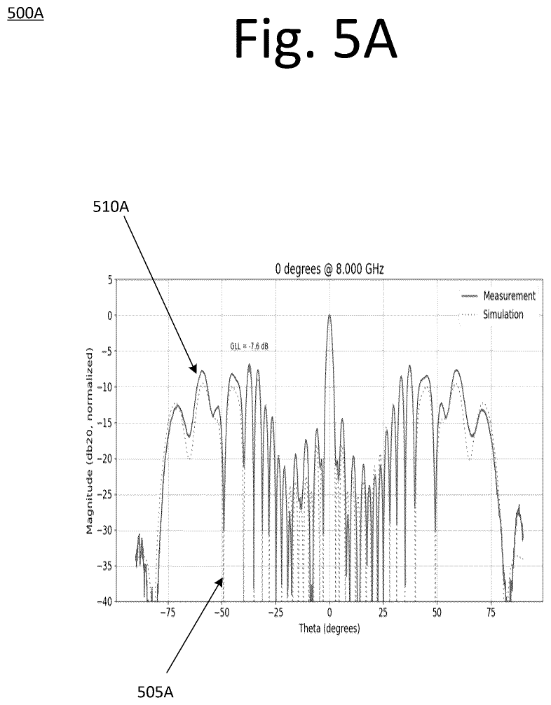

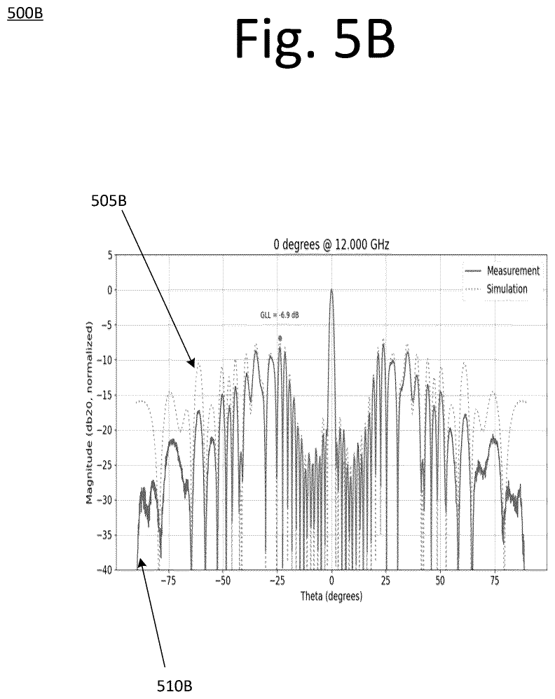

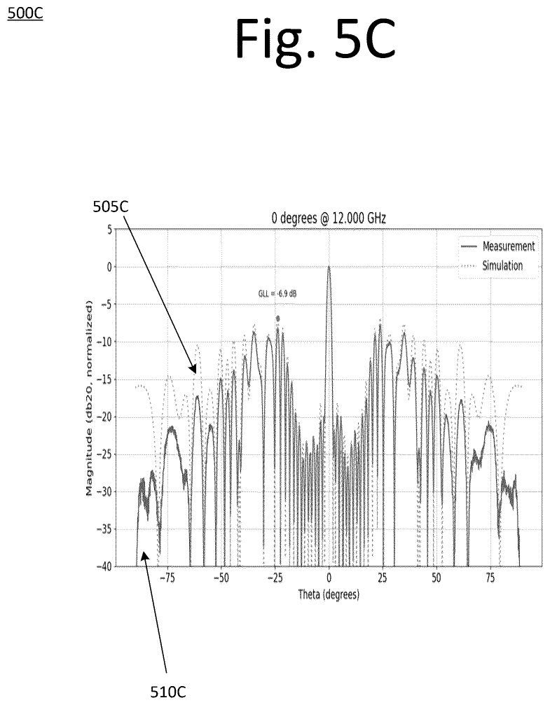

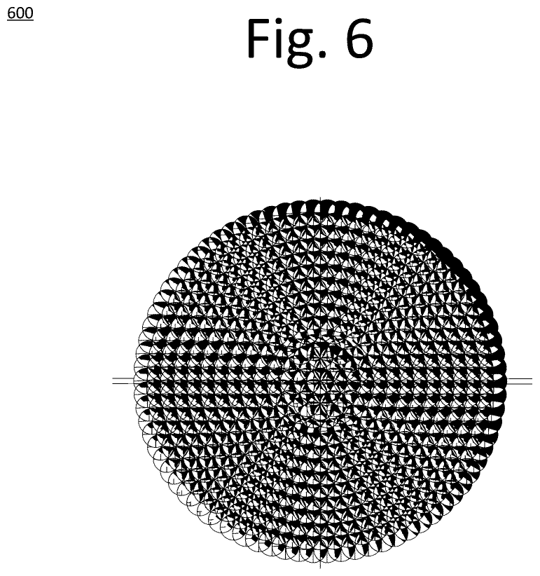

FIG. 5A is a chart 500A illustrating the radiation pattern at 8.0 GHz, according to an embodiment of the present invention. In chart 500A, the dotted line 505A shows the simulation versus the solid line 510A shows the measurement. This shows the numerical simulation is accurate and data from this chart can be extrapolated to show that other numerical simulations for other arrays may be similar.

FIG. 5B is a chart 500B showing the radiation pattern of at 12.0 GHz, according to an embodiment of the present invention. In this embodiment, chart 500B shows simulation 505B versus measurement 510B at 12.0 GHz. FIG. 5C is the radiation pattern of at 16.0 GHz, according to an embodiment of the present invention. In this embodiment, chart 500C shows simulation 505C versus measurement 510C at 16.0 GHz.

In short, FIGS. 5A-C show that, while the beam forming chips may work from 8 to 16 GHz bandwidth, the antenna array may work over a wider bandwidth.

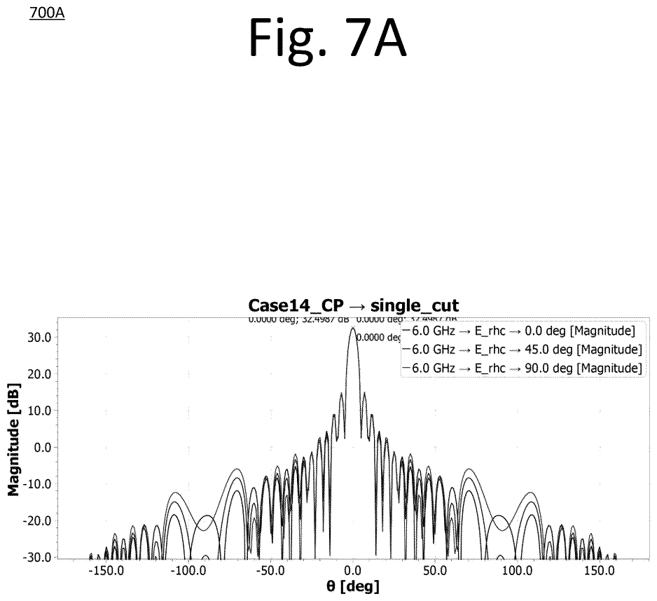

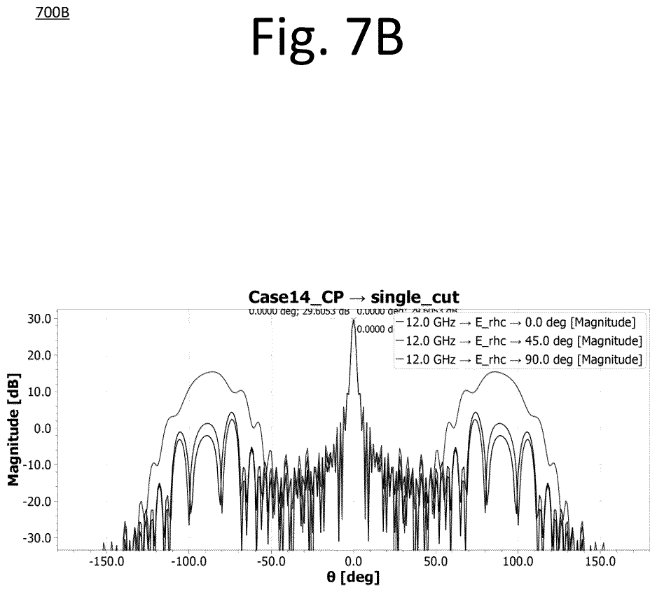

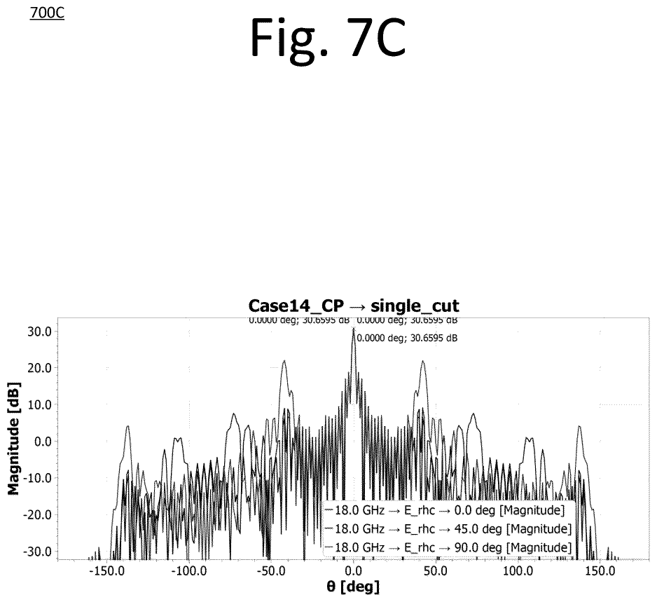

FIG. 6 is a diagram of related art showing a circular array 600 with uniform spacing. As shown in FIGS. 7A-C, the element spacing is electrically smaller at the lower frequency but becomes electrically larger at the higher frequency. It should be noted that the element size has to be large enough to operate at lower frequencies; however, this limits how close the elements can be positioned together. This causes the grating lobes to be worse at higher frequencies.

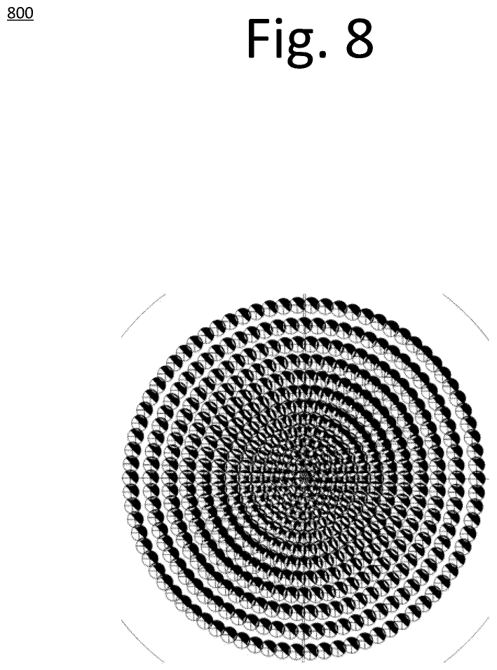

For the Circular Array, however, Tau may be multiplied by the element spacing in both the radial direction and the circumferential direction. See, for example, FIG. 8, which is a diagram illustrating a (Log Periodic) circular lattice 800 with differential spacing of Tau, according to an embodiment of the present invention. The spacing is determined by a factor of Tau, which can be a value ranging from 1.1 and 1.3 or a number greater than one. It should be noted that, if Tau is too large of a value, degradation of the grating lobe may occur, similar to conventional uniform lattice. Tau between the range of 1.1 and 1.3 may be considered optimum in certain embodiments, since two high of a Tau (e.g., greater than 1.5) may also result in degradation.

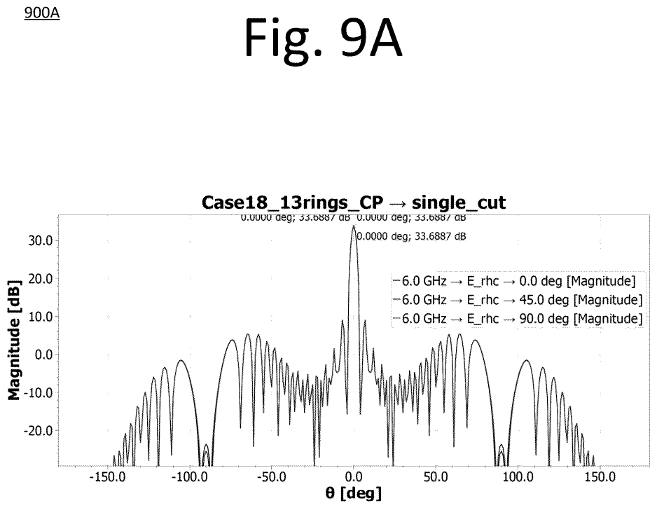

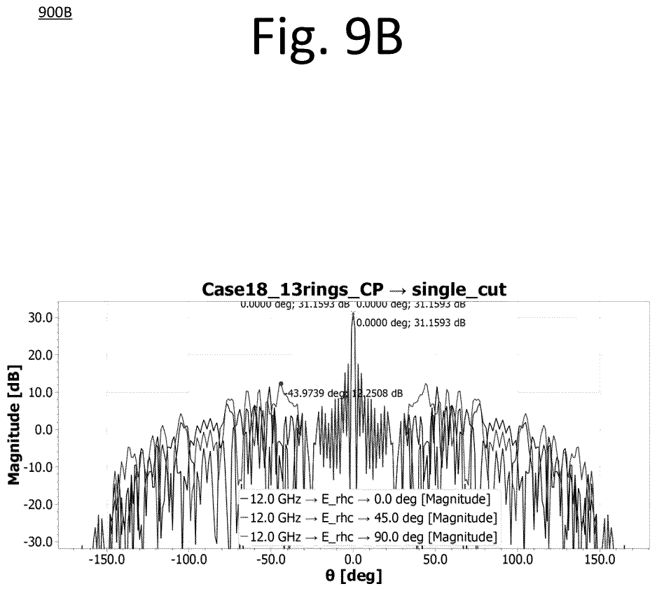

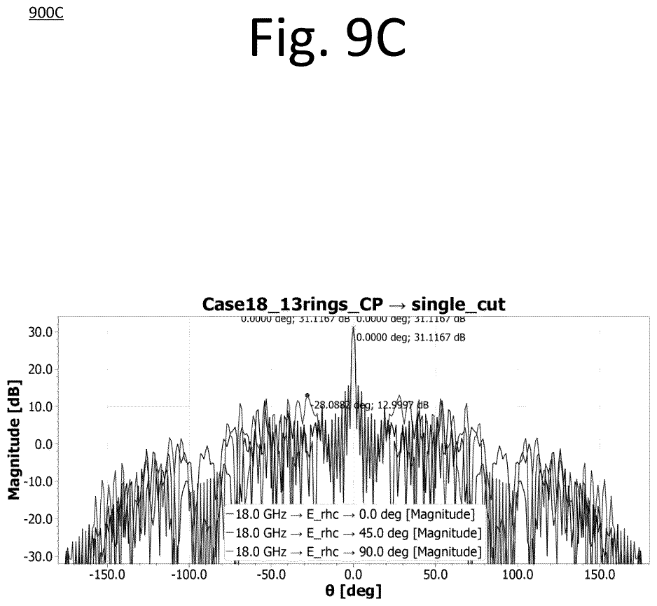

In short, in FIG. 8, the element spacing increases between the 546 antenna elements in circular lattice 800. As shown in FIGS. 9A-C, the grating lobes at 8, 12, and 16 GHz are not as high as they are in FIGS. 7A-C. The lower frequency (e.g., 8 GHz) does not show too much of a difference, because the wavelength at the lower frequency is much larger so electrical spacing between elements is much smaller. But, at the higher frequency, the difference in grating lobes can be seen in FIGS. 9B and 9C.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An array lattice for a low-density array, comprising:
a plurality of antenna elements, wherein each pair of the plurality of antenna elements are spaced such that each pair of the plurality of antenna elements have differential spacing, wherein each pair of the plurality of antenna elements have a grating lobe steered to a different angle while a main beam is the only beam that is coherently combined by each pair of the plurality of antenna elements.

2. The array lattice of claim 1, wherein, as size of the array lattice increases, the grating lobe rejection is greater with respect to the main beam.

3. The array lattice of claim 1, further comprising:
antenna element spacing in a center of the array lattice is smaller compared to antenna elements spacing in other areas of the array lattice to produce an array of antenna elements from the plurality of antenna elements have a higher density in the center and a constantly reducing density towards edges of the array lattice.

4. The array lattice of claim 3, wherein the antenna element spacing, Si, for i^{th} element in a Log Periodic array lattice start with a minimum element spacing set by a size of an ultra-wide band antenna element.

5. The array lattice of claim 4, wherein the ultra-wide band antenna element, So, is located at one side of the array lattice or is located at the center of the array lattice and the array element spacing increases outward from the center.

6. The array lattice of claim 5, wherein the differential spacing is based on a Tau factor ranging from 1.1 and 1.3.

7. The array lattice of claim 6, wherein when the plurality of antenna elements are arranged in a quasi-rectangular array, the Tau factor is multiplied by element spacing in two orthogonal directions.

8. The array lattice of claim 6, wherein when the plurality of antenna elements are arranged in a circular array, the Tau factor is multiplied by the element spacing in both radial direction and the circumferential direction.

9. An array lattice for a low-density array, comprising:
a plurality of antenna elements, wherein each pair of the plurality of antenna elements are spaced such that each pair of the plurality of antenna elements have differential spacing, wherein each pair of the plurality of antenna elements have a grating lobe steered to a different angle while a main beam is the only beam that is coherently combined by each pair of the plurality of antenna elements; and
antenna element spacing in a center of the array lattice is smaller compared to antenna elements spacing in other areas of the array lattice to produce an array of antenna elements from the plurality of antenna elements have a higher density in the center and a constantly reducing density towards edges of the array lattice.

10. The array lattice of claim 9, wherein, as size of the array lattice increases, the grating lobe rejection is greater with respect to the main beam.

11. The array lattice of claim 9, wherein the antenna element spacing, Si, for i^{th} element in a Log Periodic array lattice start with a minimum element spacing set by a size of an ultra-wide band antenna element.

12. The array lattice of claim 11, wherein the ultra-wide band antenna element, So, is located at one side of the array lattice or is located at the center of the array lattice and the array element spacing increases outward from the center.

13. The array lattice of claim 12, wherein the differential spacing is based on a Tau factor ranging from 1.1 and 1.3.

14. The array lattice of claim 13, wherein when the plurality of antenna elements are arranged in a quasi-rectangular array, the Tau factor is multiplied by element spacing in two orthogonal directions.

15. The array lattice of claim 13, wherein when the plurality of antenna elements are arranged in a circular array, the Tau factor is multiplied by the element spacing in both radial direction and the circumferential direction.

16. An array lattice for a low-density array, comprising:
a plurality of antenna elements, wherein each pair of the plurality of antenna elements are spaced such that each pair of the plurality of antenna elements have differential spacing, wherein the differential spacing is based on a Tau factor ranging from 1.1 and 1.3, and
each pair of the plurality of antenna elements have a grating lobe steered to a different angle while a main beam is the only beam that is coherently combined by each pair of the plurality of antenna elements.

17. The array lattice of claim 16, wherein, as size of the array lattice increases, the grating lobe rejection is greater with respect to the main beam.

18. The array lattice of claim 16, further comprising:
antenna element spacing in a center of the array lattice is smaller compared to antenna elements spacing in other areas of the array lattice to produce an array of antenna elements from the plurality of antenna elements have a higher density in the center and a constantly reducing density towards edges of the array lattice.

19. The array lattice of claim 18, wherein the antenna element spacing, Si, for i^{th} element in a Log Periodic array lattice start with a minimum element spacing set by a size of an ultra-wide band antenna element.

20. The array lattice of claim 19, wherein the ultra-wide band antenna element, So, is located at one side of the array lattice or is located at the center of the array lattice and the array element spacing increases outward from the center.
